(19) United States
(12) Patent Application Publication
(10) Pub. No.: US 2020/0209875 A1
(43) Pub. Date: Jul. 2, 2020

(54) SYSTEM AND METHOD FOR TRAINING AND OPERATING AN AUTONOMOUS VEHICLE

(71) Applicant: Samsung Electronics Co., Ltd., Suwon-si (KR)

(72) Inventor: Stefano Marzani, Mountain View, CA (US)

(21) Appl. No.: 16/392,205

(22) Filed: Apr. 23, 2019

Related U.S. Application Data
(60) Provisional application No. 62/787,712, filed on Jan. 2, 2019.

(51) Int. Cl. G05D 1/02; G05D 1/00; G06K 9/00; G06N 20/00

(52) U.S. Cl. CPC G05D 1/0221; G05D 1/0088; G05D 2201/0213; G06N 20/00; G06K 9/00805

(57) ABSTRACT

A method for training and operating an autonomous vehicle. The method includes operating the autonomous vehicle with a control module. The control module includes a series of sensors configured to detect objects or situations in a path of the autonomous vehicle, and a machine learning algorithm trained to classify the objects or interpret the situations detected by the sensors. The method also includes prompting a safety driver of the autonomous vehicle to provide a response when the machine learning algorithm is unable to classify one of the objects or is unable to interpret one of the situations. The method further includes receiving, at the control module, the response from the safety driver, and providing the response from the safety driver as additional training data to the machine learning algorithm.

### CROSS-REFERENCE TO RELATED APPLICATION

The present application claims priority to and the benefit of U.S. Provisional Application No. 62/787,712, filed Jan. 2, 2019, the entire content of which is incorporated herein by reference.

### FIELD

The present disclosure relates generally to systems and methods of training and operating an autonomous vehicle and keeping the safety driver involved in the control loop.

### BACKGROUND

Vehicles are becoming increasingly automated. With related art autonomous vehicles, the safety driver of the vehicle is intended to supervise the autonomous driving system. However, the average attention span of a human is only approximately 5 minutes and therefore safety drivers are likely to engage in non-supervisory activities, such as reading or texting on a smartphone, rather than continuously monitoring the operation of the autonomous vehicle. Related art autonomous vehicles are not capable of keeping the safety driver mentally and physically engaged. Accordingly, related art autonomous vehicles may increase the risk of accidents. Furthermore, one of the expensive tasks in the development of autonomous features is training the artificial intelligence to support it, and the related art does not implement an effective human-machine interaction system between a safety driver and an autonomous vehicle.

### SUMMARY

The present disclosure is directed to various methods of training and operating an autonomous vehicle. In one embodiment, the method includes operating the autonomous vehicle with a control module including a series of sensors configured to detect objects in a path of the autonomous vehicle and/or one or more driving conditions or situations, and a machine learning algorithm trained to classify the objects and/or interpret the conditions or situations detected by the plurality of sensors. The method also includes prompting a safety driver of the autonomous vehicle to provide a response when the machine learning algorithm is unable to classify one of the objects and/or unable to interpret one or the conditions or situations. The method also includes receiving, at the control module, the response from the safety driver, and providing the response from the safety driver as additional training data to the machine learning algorithm.

The prompting of the safety driver may be performed by a human-machine interface device in communication with the control module.

The human-machine interface device may be a smartphone, augmented reality glasses, virtual reality goggles, or an in-car entertainment system.

The prompting of the safety driver may include generating an auditory prompt from the human-machine interface device.

The prompting of the safety driver comprises displaying, on a display of the human-machine interface device, a visual depiction of the object or situation that the machine learning algorithm is unable to classify or interpret.

The visual depiction may include an image of a scene in a path of the autonomous vehicle and an enlarged or emphasized view of the object that the machine learning algorithm is unable to classify. In one embodiment, the visual depiction may include a graphic representation overlaid on the image of the scene (e.g., a semi-transparent or transparent red rectangle overlaid on an object in the scene).

The response may indicate whether the object or situation is hazardous or nonhazardous.

The response may indicate a classification of a nature of the object or situation that the machine learning algorithm is unable to classify or interpret.

The method may also include modifying the operation of the autonomous vehicle based on the response from the safety driver.

The modification of the operation of the autonomous vehicle may include switching from an autonomous mode to a manual mode.

The present disclosure is also directed to various embodiments of a system for training and operating an autonomous vehicle. In one embodiment, the system includes a control module configured to control the autonomous vehicle. The control module includes a series of sensors configured to detect objects in a path of the autonomous vehicle and/or one or more driving conditions or situations, and scan surroundings of the vehicle. The control module also includes nonvolatile memory having a machine learning algorithm stored therein configured to classify the objects detected by the sensors and/or interpret the situation detected by the sensors, and a processor. The nonvolatile memory includes instructions which, when executed by the processor, cause the system to prompt a safety driver of the autonomous vehicle to provide a response when the machine learning algorithm is unable to classify one of the objects and/or is unable to interpret one of the situations. The instructions, when executed by the processor, cause the control module to provide the response from the safety driver as additional training data to the machine learning algorithm.

The system may also include a human-machine interface device in communication with the control module.

The human-machine interface device may be a smartphone, augmented reality glasses, virtual reality goggles, or an in-car entertainment system.

The instructions, when executed by the processor, may cause the human-machine interface device to generate an auditory prompt when the machine learning algorithm is unable to classify one of the objects and/or is unable to interpret one of the situations.

The instructions, when executed by the processor, may cause the human-machine interface to display a visual depiction of the object the machine learning algorithm is unable to classify and/or display a visual depiction of the situation the machine learning algorithm is unable to interpret.

The visual depiction may include an image of a scene in a path of the autonomous vehicle and an enlarged or emphasized view of the object or situation the machine learning algorithm is unable to classify or interpret.

The human-machine interface may be configured to receive an auditory response from the safety driver in response to the prompt.

The human-machine interface device may include a display configured to display a visual depiction of the object that the machine learning algorithm is unable to classify, a speaker configured to generate an auditory prompt to the safety driver, a microphone configured to receive an auditory response from the safety driver, a camera, and a network adapter configured to communicate the auditory response to the control module.

The present disclosure is also directed to various embodiments of a computer readable medium having software instructions stored thereon which, when executed by a processor, cause the processor to classify objects or interpret situations, with a machine learning algorithm, detected by a plurality of sensors of an autonomous vehicle, prompt a safety driver of the autonomous vehicle to provide a response when the machine learning algorithm is unable to classify one of the objects or is unable to interpret one of the situations, receive the response from the safety driver, and provide the response from the safety driver as additional training data to the machine learning algorithm.

The software instructions, when executed by the processor, may further cause the processor to display, on a human-machine interface device, a visual depiction of the one of the objects or the one of the situations the machine learning algorithm is unable to classify or interpret.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

These and other features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a perspective view of a system for controlling and training an autonomous vehicle and keeping the driver in the control loop, according to one embodiment of the present disclosure;

FIG. 2 is a block diagram of the embodiment of the system illustrated in FIG. 1; and

FIG. 3 is a flowchart illustrating tasks of a method for controlling and training an autonomous vehicle according to one embodiment of the present disclosure.

### DETAILED DESCRIPTION

The present disclosure is directed to various embodiments of systems and methods for controlling and training an autonomous vehicle. The autonomous vehicle includes a control module including sensors, such as one or more cameras, radars, and/or lidars, configured to detect objects in a path of the autonomous vehicle and/or one or more driving conditions or situations. The control module also includes a machine learning algorithm that has been trained with a training set to scan the surroundings of the vehicle and classify the objects present in the scene and/or interpret the driving conditions or situations (e.g., classify the objects in the scene as hazardous or nonhazardous) and, based on the classification of the objects and/or the interpretations of the driving conditions or situations, to control the autonomous vehicle (e.g., control the steering, braking, and/or acceleration of the vehicle to avoid objects or situations that have been classified or interpreted as hazardous). The systems and methods of the present disclosure are configured to solicit input from a safety driver of the autonomous vehicle when the machine learning algorithm is unable to classify an object in the scene detected by the one or more sensors and/or when the machine learning algorithm unable to accurately interpret one or more driving conditions or situations, such as road conditions (e.g., wet from rain) or driving dynamics or controls (e.g., vibrations in the steering column). Additionally, based on the input from the safety driver, the systems and methods of the present disclosure are configured to provide additional training data for training the machine learning algorithm. In this manner, with a frequent request and response dialogue between the vehicle and the driver, the systems and methods of the present disclosure are configured to actively engage the safety driver during autonomous driving and enable the safety driver to contribute to the training of the autonomous driving system, both of which tend to improve the safety of the autonomous vehicle and reduce the number of accidents. As used herein, the term “autonomous vehicle” refers to both fully autonomous vehicles, such as Level-IV and Level-V vehicles, and semi-autonomous vehicles, such as Level-II or Level-III vehicles.

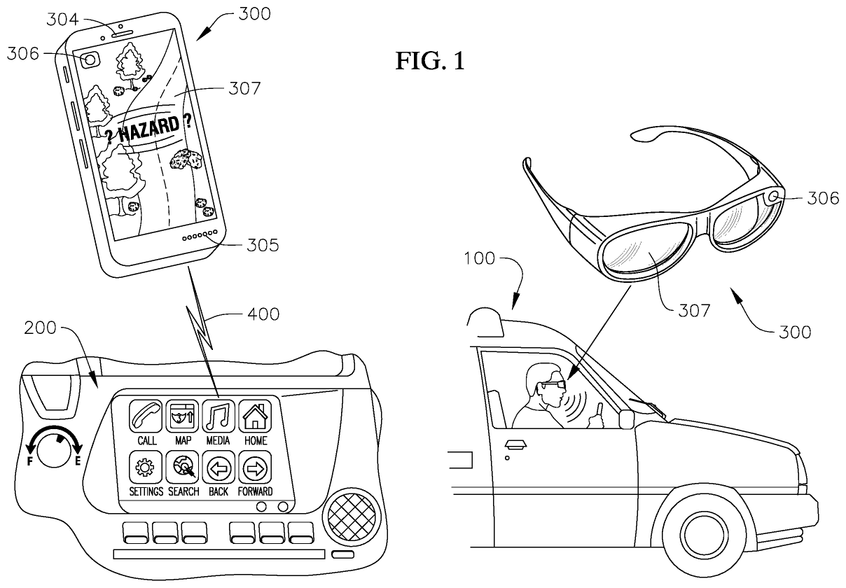

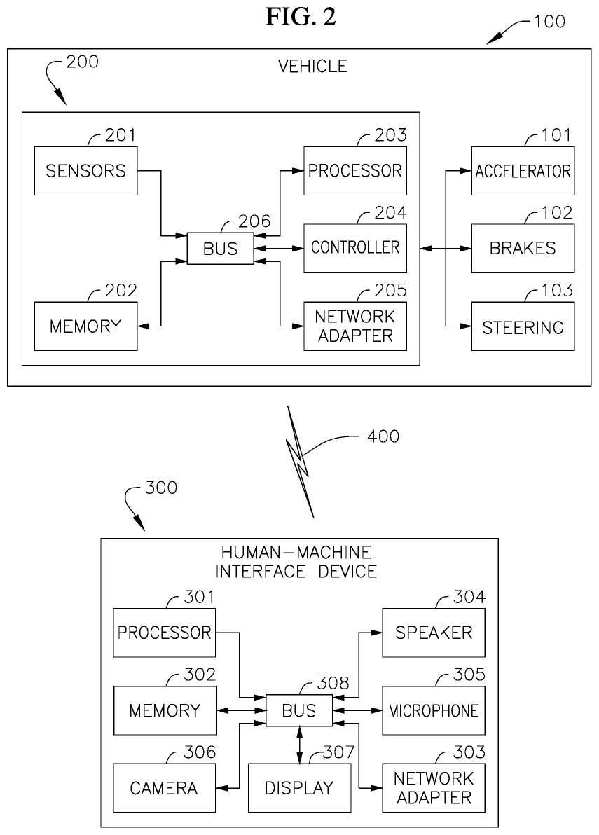

FIGS. 1-2 are a perspective view and a block diagram, respectively, of a system for operating an autonomous vehicle 100 according to one embodiment of the present disclosure. In the illustrated embodiment, the system includes a control module 200 of the autonomous vehicle 100 and a human-machine interface device 300 configured to receive input from a user (e.g., a safety driver of the autonomous vehicle or a passenger in the autonomous vehicle) and communicate with the control module 200 over a network 400. In one or more embodiments, the human-machine interface device 300 may be configured to communicate with the control module 200 via an electrical connection (e.g., a universal serial bus (USB) cable). In the illustrated embodiment, the control module 200 includes one or more sensors 201 (e.g., one or more cameras, radars, and/or lidars), nonvolatile memory 202, a processor 203, a controller 204, and a network adapter 205. Additionally, in the illustrated embodiment, the control module 200 includes a system bus 206 over which the sensors 201, the memory 202, the processor 203, the controller 204, and the network adapter 205 communicate with each other.

The sensors 201 are configured to scan the surroundings of the autonomous vehicle 100 and detect objects in a path of the autonomous vehicle 100 (e.g., other vehicles, lane dividers, lane markings, and pedestrians) or in a field of view of the sensors 201 that includes the path of the autonomous vehicle 100. In one or more embodiments, the sensors 201 may be configured to detect one or more driving conditions or situations, such as road conditions and/or driving dynamics. The nonvolatile memory 202 has a machine learning algorithm (e.g., an artificial neural network, such as a feedforward neural network or a convolutional neural network) stored therein which has been trained by a training data set to classify the objects detected by the sensors 201 and/or interpret the driving conditions or situations when the machine learning algorithm is executed by the processor 203 (e.g., classify the objects as hazardous or nonhazardous and/or the nature of the objects, such as a car, a pedestrian, or a street sign). Based on the classification of the objects detected by the sensors 201 and/or the interpretation of the driving conditions or situations, the controller 204 is configured to control one or more controls of the autonomous vehicle 100 (e.g., the accelerator 101, brakes 102, and/or steering 103 of the autonomous vehicle 100).

The term “processor” is used herein to include any combination of hardware, firmware, and software, employed to process data or digital signals. The hardware of a processor may include, for example, application specific integrated circuits (ASICs), general purpose or special purpose central processors (CPUs), digital signal processors (DSPs), graphics processors (GPUs), and programmable logic devices such as field programmable gate arrays (FPGAs). In a processor, as used herein, each function is performed either by hardware configured, i.e., hard-wired, to perform that function, or by more general purpose hardware, such as a CPU, configured to execute instructions stored in a non-transitory storage medium. A processor may be fabricated on a single printed wiring board (PWB) or distributed over several interconnected PWBs. A processor may contain other processors; for example a processor may include two processors, an FPGA and a CPU, interconnected on a PWB.

The human-machine interface device 300 may be operated by a safety driver of the autonomous vehicle 100 or a passenger in the autonomous vehicle 100. In the illustrated embodiment, the human-machine interface device 300 includes a processor 301, nonvolatile memory 302, a network adapter 303 configured to enable communication with the control module 200, a speaker 304, a microphone 305, a camera 306, and a display 307 (e.g., a liquid crystal display (LCD) or a light emitting diode (LED) display). Additionally, in the illustrated embodiment, the human-machine interface device 300 includes a system bus 308 over which the processor 301, the memory 302, the network adapter 303, the speaker 304, the microphone 305, the camera 306, and the display 307 communicate with each other.

In one or more embodiments, the human-machine interface device 300 may be a smartphone, as illustrated, for example, in FIG. 1. In one or more embodiments, the human-machine interface device 300 may be a wearable electronic device, such as augmented reality glasses or virtual reality goggles, as illustrated in FIG. 1, that may be worn by the safety driver or a passenger in the autonomous vehicle 100. In one or more embodiments, the human-machine interface device 300 may be integrated into the autonomous vehicle 100 (e.g., the human-machine interface device 300 may be an in-car entertainment system of the autonomous vehicle 100). In one or more embodiments, the human-machine interface device 300 may be a heads-up display (HUD) on the windshield of the autonomous vehicle 100.

In one embodiment, the memory 202 of the control module 200 includes instructions stored therein which, when executed by the processor 203, cause the control module 200 to communicate with the human-machine interface device 300 (e.g., via the network adapters 205, 303) and cause the speaker 304 of the human-machine interface device 300 to generate an auditory prompt to the safety driver or a passenger of the autonomous vehicle 100 when the machine learning algorithm is unable to classify an object detected by the sensors 201 and/or when the machine learning algorithm unable to accurately interpret one or more driving conditions or situations (e.g., the control module 200 may be configured to cause the speaker of the human-machine interface device 300 to generate an auditory prompt when the machine learning algorithm has a degree of uncertainty regarding the classification of the object and/or the interpretation of one or more driving conditions or situations above a threshold level of uncertainty). For example, the auditory prompt may ask the safety driver or a passenger to indicate whether an object detected by the sensors 201 is hazardous (e.g., a pedestrian) or non-hazardous depending on the interpretation of the driving conditions or the situation. In one or more embodiments, the auditory prompt may ask the safety driver or a passenger to identify a classification of the object (e.g., car, pedestrian, street sign, etc.). In one or more embodiments, the auditory prompt may aid in semantic segmentation (e.g., the auditory prompt may state, “driver, is the highlighted area a road surface?”). In one or more embodiments, the auditory prompt may be utilized to perform generic risk assessment (e.g., the auditory prompt may state, “driver, is this a risky situation? May I continue to drive? Please focus on the road to help me”).

In the illustrated embodiment, the response from the safety driver may be input into the human-machine interface device 300 by the microphone 305. In one or more embodiments, the response from the safety driver may be input into the human-machine interface device 300 in any other suitable manner. For instance, in one or more embodiments, the response from the safety driver may be input by the safety driver engaging the display 307 (e.g., a touch screen display) of the human-machine interface device 300. In one or more embodiments, the response from the safety driver may include feedback regarding the quality of the vehicle dynamics or controls (e.g., the driver may state, “Bixbi, the car shook too much while steering”). In one or more embodiments, the response from the safety driver may supply metadata (e.g., the auditory prompt and the driver response may be as follows: “Bixbi, note that it's raining”, “Ok Driver, noted. Is the road fully wet?”, “Not yet, just started”)

In one or more embodiments, the memory 202 of the control module 200 includes instructions stored therein which, when executed by the processor 203, cause the control module 200 to communicate with the human-machine interface device 300 (e.g., via the network adapters 205, 303) and cause the display 307 of the human-machine interface device 300 to display an image of the object and/or other driving conditions or situations detected by the sensors 201 of the control module 200. In one or more embodiments, the instructions stored in the memory 202 of the control module 200 may cause the display 307 to display an image captured by one of the sensors 201 (e.g., a camera) of the control module 200 (e.g., an image of a scene in a path of the autonomous vehicle 100), and display one or more visual indicia overlaid on the image identifying the object that cannot be classified by the machine learning algorithm or cannot be classified by the machine learning algorithm with a threshold degree of certainty. For instance, in one or more embodiments, the memory 202 of the control module 200 may include instructions which, when executed by the processor 203, cause the control module 200 to communicate with the human-machine interface device 300 and cause the display 307 of the human-machine interface device 300 to display an image of the scene in the path of the autonomous vehicle 100 and one or more indicia (e.g., a circle or a rectangle) around the object or situation that cannot be classified or interpreted by the machine learning algorithm or cannot be classified or interpreted by the machine learning algorithm with a threshold degree of certainty. In one or more embodiments, the memory 202 of the control module 200 may include instructions which, when executed by the processor 203, cause the control module 200 to communicate with the human-machine interface device 300 and cause the display 307 of the human-machine interface device 300 to display an image of a scene in a path of the autonomous vehicle including an enlarged view of the object or the situation that cannot be classified or interpreted by the machine learning algorithm or cannot be classified or interpreted by the machine learning algorithm with a threshold degree of certainty.

The memory 302 of the human-machine interface device 300 includes instructions stored therein which, when executed by the processor 301, cause the human-machine interface device 300 to communicate the response (e.g., the verbal response or the touch input into the touch screen display 307) from the safety driver of the autonomous vehicle to the control module 200 (e.g., via the network adapters 205, 303).

The instructions stored in the memory 202 of the control module 200 are configured to supply the input from the safety driver (e.g., the verbal response or the touch screen input from the safety driver) as additional training data for training the machine learning algorithm (i.e., the instructions stored in the memory 202 of the control module 200 are configured to provide additional training data to the machine learning algorithm based on the input from the safety driver in response to a prompt regarding an object or situation that cannot be classified or interpreted, or cannot be classified or interpreted with a threshold degree of certainty, by the machine learning algorithm of the control unit 200). In this manner, the system of the present disclosure is configured to actively engage the safety driver during autonomous driving and enable the safety driver to contribute to the training of the machine learning algorithm for controlling the autonomous vehicle 100.

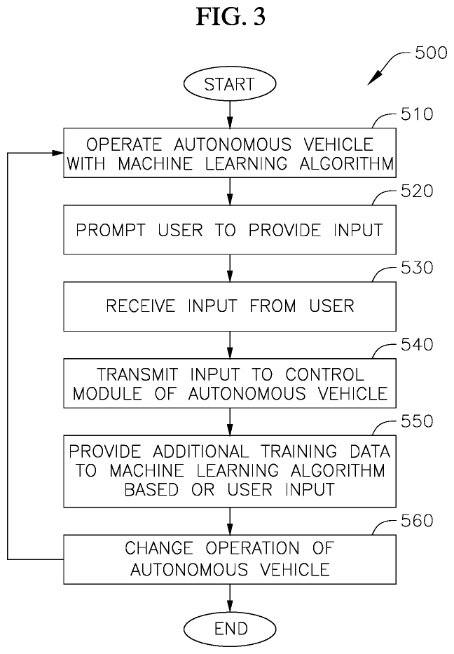

FIG. 3 is a flowchart illustrating tasks of a method 500 of operating and training an autonomous vehicle according to one embodiment of the present disclosure. In the illustrated embodiment, the method 500 includes a task 510 of operating an autonomous vehicle with a control module. The control module includes one or more sensors (e.g., one or more cameras, radars, and/or lidars) configured to scan the surroundings of the autonomous vehicle 100 and detect objects or situations in a path of the autonomous vehicle 100 or within a field a view of the sensors (e.g., other vehicles, lane dividers, lane markings, and pedestrians). Additionally, the control module includes a machine learning algorithm that has been trained (e.g., with one or more training data sets) to classify objects detected by the sensors and/or interpret the driving conditions or situations (e.g., objects or situations in a path of travel of the autonomous vehicle detected by the sensor, or objects or situations detected in a field of view of the sensors). In one or more embodiments, the machine learning algorithm may be configured to classify the objected detected by the sensors as hazardous or nonhazardous and/or the machine learning algorithm may be configured to classify the nature of the objects (e.g., car, pedestrian, street sign, etc.). In one or more embodiments, the machine learning algorithm may be configured to interpret the one or more driving conditions or situations. The control module also includes a controller configured to control one or more controls of the autonomous vehicle (e.g., the acceleration, braking, and/or steering of the autonomous vehicle) based on the classification of the objects detected by the sensors and/or the interpretation of the driving conditions or situation. In one or more embodiments, the control module may be the same as or similar to the embodiment of the control module 200 illustrated in FIGS. 1-2.

In the illustrated embodiment, the method 500 also includes a task 520 of prompting a safety driver or a passenger of the autonomous vehicle to provide a response when the machine learning algorithm is unable to classify an object and/or interpret a situation, or unable to classify an object and/or interpret a situation with a threshold degree of certainty, detected by the sensors. The control module may include instructions which, when executed by a processor, cause the control module to communicate with a human-machine interface device (e.g., a heads-up display (HUD) on a windshield of the autonomous vehicle, a smartphone inside the autonomous vehicle, augmented reality glasses worn by the safety driver of the autonomous vehicle, virtual reality goggles worn by the safety driver, or any other suitable electronic device) and cause the human-machine interface device to generate the prompt. The prompt may include an auditory question played through a speaker of a human-machine interface device and/or a visualization displayed on a display of the human-machine interface device. The visualization may include a scene in a path of the autonomous vehicle captured by a camera of the control module (e.g., a scene having the object circled or a scene with the object enlarged).

In the illustrated embodiment, the method 500 also includes a task 530 of receiving, at the human-machine interface device, input from the safety driver a passenger in the autonomous vehicle in response to the prompt. In one or more embodiments, the input from the safety driver or the passenger may include an indication whether the object or situation that cannot be classified or interpreted (or cannot be classified or interpreted with a threshold degree of certainty) by the machine learning algorithm is hazardous (e.g., a car or a pedestrian, or dangerous driving conditions, such as a wet road) or nonhazardous (e.g., shrubbery alongside a roadway along which the autonomous vehicle is traveling). In one or more embodiments, the input from the safety driver or the passenger may identify a classification of the object (e.g., car, pedestrian, street sign, etc.) and/or may interpret the situation (e.g., a wet road).

In the illustrated embodiment, the method 500 also includes a task 540 of transmitting the input of the safety driver or the passenger from the human-machine interface device to the control module of the autonomous vehicle (e.g., via network adapters or via a direct electrical connection).

Additionally, in the illustrated embodiment, the method 500 includes a task 550 of supplying, by the human-machine interface device, the input or response from the safety driver or the passenger as additional training data for training the machine learning algorithm (i.e., providing additional training data to the machine learning algorithm based on the input from the safety driver or the passenger in response to a prompt regarding an object or situation that cannot be classified or interpreted, or cannot be classified or interpreted with a threshold degree of certainty, by the machine learning algorithm of the control unit). In this manner, the method 500 of the present disclosure is configured to actively engage the safety driver during autonomous driving and enable the safety driver to contribute to the training of the machine learning algorithm for controlling the autonomous vehicle.

Furthermore, in the illustrated embodiment, the method 500 also includes a task 560 of changing the operation of the autonomous vehicle based on the input received from the safety driver or a passenger of the autonomous vehicle. In one or more embodiments, the task 560 of changing the operation of the autonomous vehicle may include actuating the accelerator, the brakes, and/or the steering system of the autonomous vehicle to avoid an object or a situation that the safety driver or a passenger of the autonomous vehicle has identified as hazardous. In one or more embodiments, the task 560 of changing the operation of the autonomous vehicle may include disengaging an autonomous driving mode of the autonomous vehicle (i.e., a handover event in which an autonomous driving mode is switched to a manual driving mode in which the safety driver is in control of the operation of the vehicle).

While this disclosure has been described in detail with particular references to exemplary embodiments thereof, the exemplary embodiments described herein are not intended to be exhaustive or to limit the scope of the disclosure to the exact forms disclosed. Persons skilled in the art and technology to which this disclosure pertains will appreciate that alterations and changes in the described structures and methods of assembly and operation can be practiced without meaningfully departing from the principles, spirit, and scope of this disclosure, as set forth in the following claims.

Example embodiments have been described herein in detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

What is claimed is:

1. A method for training and operating an autonomous vehicle, the method comprising:
operating the autonomous vehicle with a control module, the control module comprising a plurality of sensors configured to detect objects or situations in a path of the autonomous vehicle, and a machine learning algorithm trained to classify the objects or interpret the situations detected by the plurality of sensors;
prompting a safety driver of the autonomous vehicle to provide a response when the machine learning algorithm is unable to classify one of the objects or is unable to interpret one of the situations;
receiving, at the control module, the response from the safety driver; and
providing the response from the safety driver as additional training data to the machine learning algorithm.

2. The method of claim 1, wherein the prompting of the safety driver is performed by a human-machine interface device in communication with the control module.

3. The method of claim 2, wherein the human-machine interface device is a device selected from the group of devices consisting of a heads-up display, a smartphone, augmented reality glasses, virtual reality goggles, and an in-car entertainment system.

4. The method of claim 2, wherein the prompting the safety driver comprises generating an auditory prompt from the human-machine interface device.

5. The method of claim 2, wherein the prompting the safety driver comprises displaying, on a display of the human-machine interface device, a visual depiction of the one of the objects or the one of the situations the machine learning algorithm is unable to classify or interpret.

6. The method of claim 5, wherein the visual depiction comprises an image of a scene in a path of the autonomous vehicle and an enlarged view of the one of the objects or the one of the situations the machine learning algorithm is unable to classify or interpret.

7. The method of claim 1, wherein the response indicates whether the one of the objects is hazardous or nonhazardous.

8. The method of claim 1, wherein the response indicates a classification of a nature of the one of the objects the machine learning algorithm is unable to classify or an interpretation of the one of the situations the machine learning algorithm is unable to interpret.

9. The method of claim 1, further comprising modifying the operating of the autonomous vehicle based on the response from the safety driver.

10. The method of claim 9, wherein the modifying the operating of the autonomous vehicle comprises switching from an autonomous mode to a manual mode.

11. A system for training and operating an autonomous vehicle, the system comprising:
a control module configured to control the autonomous vehicle, the control module comprising:
a plurality of sensors configured to detect objects or situations in a path of the autonomous vehicle;
nonvolatile memory having a machine learning algorithm stored therein configured to classify the objects or interpret the situations detected by the plurality of sensors; and
a processor,
wherein the nonvolatile memory includes instructions which, when executed by the processor, cause the system to prompt a safety driver of the autonomous vehicle to provide a response when the machine learning algorithm is unable to classify one of the objects or is unable to interpret one of the situations, and
wherein the instructions, when executed by the processor, cause the control module to provide the response from the safety driver as additional training data to the machine learning algorithm.

12. The system of claim 11, further comprising a human-machine interface device in communication with the control module.

13. The system of claim 12, wherein the human-machine interface device is a device selected from the group of devices consisting of a heads-up display, a smartphone, augmented reality glasses, virtual reality goggles, and an in-car entertainment system.

14. The system of claim 12, wherein the instructions, when executed by the processor, cause the human-machine interface device to generate an auditory prompt when the machine learning algorithm is unable to classify one of the objects or is unable to interpret one of the situations.

15. The system of claim 12, wherein the instructions, when executed by the processor, cause the human-machine interface to display a visual depiction of the one of the objects or the one of the situations the machine learning algorithm is unable to classify or interpret.

16. The system of claim 15, wherein the visual depiction comprises an image of a scene in a path of the autonomous vehicle and an enlarged view of the one of the objects or the one or more situations the machine learning algorithm is unable to classify or interpret.

17. The system of claim 12, wherein the human-machine interface is configured to receive an auditory response from the safety driver in response to the prompt.

18. The system of claim 12, wherein the human-machine interface device comprises:
a display configured to display a visual depiction of the one of the objects or the one of the situations that the machine learning algorithm is unable to classify or interpret;
a speaker configured to generate an auditory prompt to the safety driver;
a microphone configured to receive an auditory response from the safety driver;
a camera; and
a network adapter configured to communicate the auditory response to the control module.

19. A computer readable medium having software instructions stored thereon which, when executed by a processor, cause the processor to:
classify objects or interpret situations, with a machine learning algorithm, detected by a plurality of sensors of an autonomous vehicle;
prompt a safety driver of the autonomous vehicle to provide a response when the machine learning algorithm is unable to classify one of the objects or is unable to interpret one of the situations;
receive the response from the safety driver; and
provide the response from the safety driver as additional training data to the machine learning algorithm.

20. The computer readable storage medium of claim 19, wherein the software instructions, when executed by the processor, further cause the processor to display, on a human-machine interface device, a visual depiction of the one of the objects or the one of the situations the machine learning algorithm is unable to classify or interpret.
